(19) United States
(12) Patent Application Publication
(10) Pub. No.: US 2023/0069167 A1
(43) Pub. Date: Mar. 2, 2023

(54) METHOD FOR CO-PRODUCING IODINE AND SALT

(71) Applicants: TOHO EARTHTECH, INC., Niigata (JP); MITSUBISHI GAS CHEMICAL COMPANY, INC., Tokyo (JP); GODO SHIGEN CO., LTD., Tokyo (JP)

(72) Inventors: Masaharu DOYA, Niigata (JP); Toru TSUKAGOSHI, Niigata (JP)

(21) Appl. No.: 17/758,058

(22) PCT Filed: Dec. 22, 2020
(86) PCT No.: PCT/JP2020/048010

§ 371 Date: Jun. 27, 2022

(30) Foreign Application Priority Data
Dec. 27, 2019 (JP) 2019-238395

(51) Int. Cl. B01D 61/46; C01D 3/14; C01D 3/06; C01B 7/14

(52) U.S. Cl. CPC B01D 61/461; C01D 3/145; C01D 3/06; C01B 7/14; B01D 2311/08; A23L 27/40

(57) ABSTRACT

Provided is a method for co-producing iodine and salt by use of underground brine containing iodine salt and sodium chloride. The method is a method to produce iodine and salt in parallel including a series of steps including: an iodine acquisition step; a collecting step for obtaining concentrated brine by simultaneously concentrating iodine salt and sodium chloride by using an electrodialysis device; and a roasting step for obtaining salt. The present invention encompasses various aspects in terms of the order of performing the iodine acquisition step, the collecting step, and the roasting step, which are included in the series of steps.

### TECHNICAL FIELD

The present invention relates to a method for co-producing iodine and salt in which iodine and salt are produced in parallel.

### BACKGROUND

Iodine is one of the essential biological elements necessary for survival and growth of vertebrates such as humans and animals, and it is said that an adult needs to take 0.014 to 0.033 mg per day. It is known that iodine deficiency in a human body may cause disabilities such as deterioration of metabolism, weakness, growth disability, delayed mental development and cretinism, and iodine deficiency in livestock feed may cause diseases such as hoof disease and goiter. Therefore, in landlocked countries such as the United States and Switzerland, the addition of iodine salt is often obligatory in order to prevent iodine deficiency disorders.

On the other hand, most of the salt currently available in Japan is industrially produced by a salt-making method in which seawater is concentrated by electrodialysis, or collected, to obtain concentrated water having a sodium chloride concentration of 180 g/L or mole, and the concentrated water is heated and concentrated, or roasted, to obtain a slurry liquid in which crystals containing sodium chloride as a main component are precipitated and separated into crystals and a mother liquor (bittern liquid) by centrifugation or the like. Since the iodine content of seawater is as low as about 0.05 mg/L, the iodine content of salt produced from seawater is usually extremely low. For example, the iodine content of the salt obtained by the above method is approximately 0.3 mg/kg, and the iodine content of the salt obtained by dissolving and recrystallizing imported sun-dried salt is 0.1 mg/kg (Non-patent Document 1).

Patent Document 1 discloses a salt-based composition having an improved salty taste, wherein the salt is obtained by adding a liquid obtained by boiling and filtering natural underground brine containing iodine to a salt or a salt mixture containing salt as a main component produced by a process including an ion exchange treatment and mixing substantially uniformly. The water content is substantially equal to or less than the insoluble amount of the mixture. However, in general, natural underground brine often contains high concentration of unwanted components such as transition metals exemplified by iron and manganese, and/or organic polymers exemplified by fulvic acid, while it is not easy to remove them by filtration as is commonly performed. Therefore, it is extremely difficult to industrially produce salt from underground brine while preventing the contamination of these unnecessary components.

Non-Patent Document 2 shows a diagram for comprehensively producing salt, iodine, etc. from natural underground brine. However, no specific method for economically producing each compound is described.

By the way, natural gas is roughly classified into structural gas and water-soluble gas. Of these, water-soluble natural gas is dissolved in underground brine buried in the underground aquifer. When this is pumped up to the surface of the earth by a pumping well installed underground and water-soluble natural gas is vaporized and collected, underground brine remains. Underground brine may contain iodine salts in a high concentration, other than salt components similar to seawater such as sodium chloride, potassium chloride, calcium chloride, and magnesium sulfate. It is known that underground brine containing a high concentration of iodine salts can be obtained in some areas in Japan and oil mining sites in the United States and Russia.

### RELATED ART DOCUMENTS

### Patent Document

Patent Document: 1 Japanese Patent Application Laid-Open No. H08-38100A

### Non-Patent Documents

Non-Patent Document 1: Shinno et al., Journal of the Japan Society of Sea Water Science, 2003, Vol. 57, No. 2, p. 134-137
Non-Patent Document 2: Nozaki, Fujishiro “Iodine and its industry” Tokyo Denki University Press, p. 209

### SUMMARY

### Problems to be Solved by the Invention

In the prior art, an industrial method for co-producing iodine and salt from underground brine has not been known.

An object of the present invention is to provide a method for co-producing iodine and salt, which can efficiently co-produce iodine and salt. In the present invention, salt is a concept including “iodine-containing salt” containing iodine as a constituent component.

### Means for Solving Problems

Such an object is achieved by the present invention as following.

The method for co-producing iodine and salt of the present invention is a method for producing iodine and salt using underground brine containing iodine salt and sodium chloride.

It has a series of steps including an iodine acquisition step, a collecting step of simultaneously concentrating iodine salt and sodium chloride using an electrodialysis device to obtain concentrated brine, and a roasting step to obtain salt. It is a method for producing the iodine and the salt in parallel.

In other words, the present invention is a method to produce both iodine and salt by passing through a series of steps including an iodine acquisition step, a collecting step using an electrodialysis device, and a roasting step for obtaining salt using underground brine containing iodine salt and sodium chloride as a mw material. In particular, by simultaneously concentrating iodine ions and sodium chloride in underground brine using an electrodialysis device, both iodine and salt can be efficiently produced.

Various aspects are included as the order of performing the iodine acquisition step, the collecting step, and the roasting step. Further, the iodine acquisition step, the collecting step, and the roasting step may be carried out at the same time, or may be carried out sequentially for each step.

One aspect of the present invention is a method in which the collecting step, the roasting step, and the iodine acquisition step are carried out in this order in a series of steps in the manufacturing method described in the preceding paragraph.

Another aspect of the present invention is a method in which the iodine acquisition step, the collecting step, and the roasting step are carried out in this order in a series of steps in the manufacturing method described in the preceding paragraph.

Another aspect of the present invention is a method in which the collecting step, the iodine acquisition step, and the roasting step are carried out in this order in a series of steps in the manufacturing method described in the preceding paragraph.

According to the present invention, iodine and salt are industrially and efficiently co-produced. In particular, iodine and iodine-containing salt can be efficiently obtained at the same time.

Further, in the present invention, by recycling and using the waste water remaining after producing iodine and salt in the process, the acquisition rate of iodine contained in the raw material underground brine becomes particularly high, and it is possible to efficiently take out iodine, which is a valuable natural resource, from underground brine.

The present invention can be suitably applied to underground brine containing a large amount of transition metal ions such as iron and manganese, and/or organic polymers.

### BRIEF DESCRIPTION OF THE FIGURES

FIG. 1 is a flow chart showing a method for co-producing iodine and salt according to the first embodiment of the present invention.

FIG. 2 is a flow chart showing a method for co-producing iodine and salt according to the second embodiment of the present invention.

FIG. 3 is a flow chart showing a method for co-producing iodine and salt according to the third embodiment of the present invention.

### DETAILED DESCRIPTION

Hereinafter, preferred embodiments of the present invention will be described in detail.

### First Embodiment

First, the method for co-producing iodine and salt of the present invention according to the first embodiment will be described.

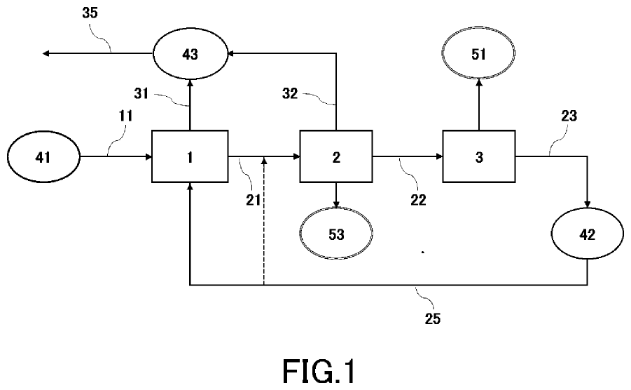

FIG. 1 is a flow chart showing a method for co-producing iodine and salt according to the first embodiment of the present invention.

The method for co-producing iodine and salt of the present invention is a method for co-producing iodine and salt using underground brine containing iodine salt and sodium chloride, and is a method of producing the iodine and the salt in parallel, which comprises a series of steps including an iodine acquisition step, a collecting step of simultaneously concentrating an iodine salt and sodium chloride using an electrodialysis device for obtaining concentrated brine and a roasting step for obtaining salt.

As a result, iodine and salt can be efficiently co-produced. In particular, iodine and iodine-containing salt can be efficiently co-produced at the same time. In addition, iodine, which is a valuable natural resource, can be efficiently taken out from brine and industrially put into a commerce.

In the present invention, salt is a concept including an iodine-containing salt which is a solid containing sodium chloride as a main component and containing iodine salt. Iodine-containing salt refers to a sodium chloride composition having an iodine ion content of 1 mg/kg or more, more preferably 5 mg/kg or more, still more preferably 10 mg/kg or more. In the present invention, the iodine ion includes all ions containing iodine atoms such as I⁻, I₃⁻, and IO₃⁻. A salt having the iodine ion as an anion is referred to an iodide salt.

The order of performing the series of the iodine acquisition step, the collecting step and the roasting step is not particularly limited. In this present embodiment, the collecting step, the roasting step, and the iodine acquisition step of the series are performed in this order.

More specifically, first, the underground brine 11 in the underground brine storage tank 41 is transported to the electrodialysis device 1 to perform a collecting step.

The concentrated brine 21 obtained in the collecting step of the electrodialysis device 1 is transported to the roasting device 2, while the low-concentration salt water 31 obtained by the electrodialysis device 1 is transported to the return water storage tank 43.

The concentrated brine 21 is subjected to the roasting step in the roasting device 2.

By the roasting step by the roasting device 2, salt 53 as a solid is obtained, and the roasting mother liquor 22 separated from the salt 53 and containing iodine at a higher concentration than the concentrated brine 21 is transported to the iodine acquisition device 3. Further, the distilled water 32 obtained by condensing the water evaporated in the roasting step is recovered as a liquid and transported to the return water storage tank 43.

The low-concentration salt water 31 and the distilled water 32 recovered in the return water storage tank 43 can be discharged to a river, for example, and preferably can be returned as the underground return water 35 to the underground from where the brine is pumped.

The iodine mother liquor 22 obtained in the roasting step in the roasting device 2 is transported to the iodine acquisition device 3 to perform the iodine acquisition step.

Iodine 51 is obtained by the iodine acquisition step in the iodine acquisition device 3. The iodine-acquired wastewater 23 remaining after the iodine 51 is acquired in the iodine acquisition step can be suitably recycled by being transferal to the recycled water storage tank 42 after adding a reducing agent or adjusting the pH as necessary, and then transferred to the electrodialysis device 1.

In this way, by performing the collecting step, the roasting step, and the iodine acquisition step in the series of steps, in this order, the following effects can be obtained. That is, in this present embodiment, since the underground brine as the object to be heated is concentrated through the collecting step and the concentration of the iodine salt increases, the iodine acquisition step becomes easier. In addition, since organic substances such as fulvic acid are removed from underground brine as an object to be treated through a collecting step, by-production of organic halogen compounds in the iodine acquisition step is effectively suppressed.

Further, since the volume of underground brine as an object to be treated is reduced, the scale and power of the apparatus in the iodine acquisition step and the amount of chemicals such as sulfuric acid to be added can be reduced. Since low-valent transition metal ions, organic substances, and other oxidizable substances are removed in the collecting step, the efficiency of the oxidizing agent used in the iodine acquisition step increases, and the iodine acquisition efficiency also increases. In addition, the precipitation of transition metal oxides is suppressed in the iodine acquisition step. Further, the effect that iodine-containing salt having a high iodine content is produced can be achieved.

### Underground Brine

In the present invention, underground brine containing iodide ion and sodium chloride is used as a raw material. Specifically, for example, underground-derived brine pumped from the ground and remaining after collecting the dissolved water-soluble natural gas can be used.

The underground brine used contains iodine ions, and the content thereof is preferably 1 mg/L or more, more preferably 10 mg/L or more, and further preferably 30 mg/L or more. Further, the underground brine used contains sodium chloride, and the content thereof is preferably 1 g/L or more, more preferably 10 g/L or more, and further preferably 20 g/L or more.

The present invention is also suitably applicable to underground brine in which at least one of iodide ion and sodium chloride is low in concentration.

In the present invention, note that the iodine ion content and the iodine ion concentration refer to the content and concentration based on the total amount of the I atoms in the ions containing iodine atoms and the free iodine contained in the object. These values are determined by titrating the extracted iodine with a sodium thiosulfate standard solution, after liberating ions containing iodine atoms contained in the object to iodine (I₂) using sodium nitrite under sulfuric acid acidity, and then extracting it with an organic solvent.

### Pretreatment

For underground brine, before performing a series of steps as described in detail later, that is, a series of steps including an iodine acquisition step, a collecting step, and a roasting step, it is preferable to perform a pretreatment for removing contamination such as insoluble matter and microorganisms in underground brine in order to prevent the occurrence of clogging in the apparatus and piping.

As the pretreatment, for example, a coagulation sedimentation step, a sand filtration step, a porous membrane filtration step, or the like, alone or in combination thereof may be performed.

Further, the underground brine may be subjected to a pretreatment for removing insoluble matter such as a transition metal oxide by filtration after aeration with air or adding an oxidizing agent to the underground brine. As the filter medium, for example, particles such as sand, coal, activated carbon, inorganic oxide or resin, microfiltration membrane or ultrafiltration membrane or other porous filtration membrane can be used. The average pow size of the porous filtration membrane is not particularly limited, but is preferably 0.01 μm or more and 1 μm or less from the viewpoint of the balance between the removal performance and the amount of permeated water.

In addition, after pumping underground brine from the underground aquifer, it is also preferable to handle it under non-oxidative atmosphere such as nitrogen and without exposing it to light, or to treat it in the form of underground brine in non-oxidative state by adding a reducing agent. The underground brine in non-oxidizing state is an underground brine having no oxidative property, and usually has an oxidation-reduction potential of 0 mV or less, preferably 0 to −50 mV as a platinum electrode potential. When underground brine is handled in anon-oxidizing state, transition metal components such as iron ions contained in the underground brine are not oxidized, so that formation of insoluble matter can be prevented more effectively. There is an advantage that the blockage of equipment and piping can be prevented more effectively.

### Collecting Step

The collecting step is a step of simultaneously concentrating iodine salt and sodium chloride in underground brine as an object to be heated, by use of an electrodialysis device.

In this step, the underground brine to be heated is divided through an electrodialysis device into concentrated brine which is an aqueous solution containing iodine salt and sodium chloride at a relatively high concentration and low-concentration salt water which is an aqueous solution containing iodine salt and sodium chloride at a relatively low concentration. Iodide ions and sodium chloride contained in the underground brine which is the object to be heated are concentrated and contained in the concentrated brine at a high concentration. Most of organic compounds, non-ionizing inorganic compounds and polyvalent ions of transition metals contained in the underground brine to be heated are contained in the low-concentration salt water and separated from the concentrated brine.

In the collecting step, the iodine ion concentration in the concentrated brine obtained by the electrodialysis device is preferably 4 times or more, more preferably 8 times or more the iodine ion concentration in the supplied underground brine which is the object to be treated.

The iodine ion concentration in the low-concentration salt water obtained after the collecting step is preferably 10 mg/L or less, more preferably 5 mg/L or less, and further preferably 3 mg/L or less.

As a result, the efficiency of obtaining iodine from underground brine can be made better.

An electrodialysis device is constituted by alternate arrangement of a plurality of anion exchange membranes and cation exchange membranes in one or more electrodialysis tanks, formation of diluting chambers and concentrating chambers between the membranes, and formation of anodes and cathode on both outer sides. The chamber partitioned by the anion exchange membrane on the anode side and the cation exchange membrane on the cathode side is the diluting chamber, while the chamber partitioned by the cation exchange membrane on the anode side and the anion exchange membrane on the cathode side is the concentrating chamber. For example, when two membranes of an anion exchange membrane and a cation exchange membrane are made into one set, preferably one set or more and 2500 sets or less are repeatedly arranged, and more preferably 10 sets or more and 1000 sets or less are repeatedly arranged.

A direct current is applied between the cathode and anode of the electrodialysis tank and underground brine, which is the object to be treated, is supplied to the diluting chamber. The supplied underground brine is separated by electrodialysis. A concentrated brine containing a relatively high concentration of iodine salt and sodium chloride is obtained from the concentrating chamber, while low concentration salt water containing a relatively low concentration of iodine salt and sodium chloride is obtained from diluting chamber. The volume ratio of the concentrated brine to the low-concentration salt water obtained is preferably 1:1 or more and 1:30 or less, more preferably 1:2 or mow and 1:20 or less, and still more preferably 1:3 or mow and 1:10.

As the anion exchange membrane used in the electrodialysis device, for example, Selemion AMV-N membrane, an ASV-N membrane (both manufactured by AGC Co., Ltd.), and a Neosepta ASE membrane (manufactured by Astom Co., Ltd.) can be used. Anions such as chloride ions and iodide ions contained in the underground brine to be treated selectively permeate the anion exchange membrane and move from the diluting chamber to the concentrating chamber.

In the present invention, it is preferable to obtain a concentrated brine in which transition metal ions have been removed by using a monovalent ion selective permeable cation exchange membrane, which is a membrane having enhanced selective permeability of monovalent cations, as a cation exchange membrane used in an electrodialysis device. As the monovalent ion selective permeable cation exchange membrane, for example, a strongly acidic styrene-divinylbenzene-based uniform cation exchange membrane or the like is used. More specifically, as the monovalent ion selective permeable cation exchange membrane, for example, Selemion CSO membrane (manufactured by AGC Co., Ltd.), Neosepta CIMS membrane (manufactured by Astom Co., Ltd.) and the like can be used.

As a result, monovalent cations such as sodium ions and potassium ions contained in the underground brine to be treated are selectively let permeate through the monovalent ion selective permeable cation exchange membrane and move from the diluting chamber to the concentrating chamber. In addition, polyvalent cations such as calcium ions, magnesium ions and transition metal ions, non-ionizing inorganic compounds and organic compounds contained in the underground brine to be treated are not allowed to permeate the ion exchange membrane. They are left in the diluting chamber, contained in low-concentration salt water and can be discharged.

Underground brine mined from the ground usually contains a large amount of transition metal ions, unlike seawater. Typically, iron ion is contained in a content of 5 mg/L or more and 20 mg/L or less, and manganese ion is contained in a content of 0.1 mg/L or more and 0.3 mg/L or less. Therefore, in order to smoothly operate the subsequent steps and maintain the quality of the product, it is preferable to remove the transition metal ions by use of a monovalent ion selective permeable cation exchange membrane in the collecting step.

In the present invention, when a combination of an anion exchange membrane and a monovalent ion selective permeable cation exchange membrane is used as the ion exchange membranes constituting the electrodialysis device, the concentration of the transition metal ions in the concentrated brine obtained by the collecting step is preferably 0.1 mg/L or less, more preferably 0.05 mg/L or less for iron ions; preferably 0.02 mg/L or less and more preferably 0.01 mg/L or less for manganese ions.

By the collecting step, concentrated brine having an increased concentration of sodium chloride and iodine salt in the underground brine to be treated can be obtained. Further, the concentrated brine obtained in this step is free from unnecessary components such as organic substances other than sodium chloride and iodine salt. Further, the concentrated brine obtained in this step is free from polyvalent ions such as calcium and transition metal ions in the underground brine which is the object to be heated, and the generation of scale or precipitation in the subsequent step can be suitably prevented. On the other hand, the low-concentration salt water obtained in this step contains sodium chloride at a relatively low concentration, and it can be discharged in a river or underground where underground brine is pumped up after being treated for environmental safety as necessary.

### Roasting Step

The roasting step is a step of obtaining solid salt by evaporating and removing water from the concentrated brine obtained through the above-mentioned collecting step. In the roasting step, a vacuum evaporation can, a direct boiling kettle or a combination thereof used for producing seawater salt can be used, and in particular, a multiple utility can be preferably used. By using a multi-stage vacuum evaporator, the latent heat of steam at each stage can be effectively used, so that energy efficiency can be further improved. A direct-boiled kettle or a combination of a multiple utility can and a direct-boiled kettle can also be used.

The salt obtained in the roasting step usually contains not only sodium chloride as a main component but also iodine.

As a result, the obtained salt can be suitably used as, for example, human food salt, livestock or pet feed salt, and the like.

In this step, in the concentrated brine obtained through the above-mentioned collecting step, a separately prepared salt component, for example, an iodine-free salt component, a salt component having a lower iodine content than the concentrated brine, or an aqueous solution thereof may be added and roasted. Thereby, iodine-containing salt having a more preferably adjusted iodine content can be obtained. Further, as compared with the case where the iodine-containing salt and the separately prepared salt component are mixed after obtaining the iodine-containing salt in the roasting step, the iodine salt was more uniformly incorporated into the solid salt. It can suppress more effectively the undesired variation in the content of iodine ions in the solid salt.

In the roasting step, iodide ions contained in the solid salt obtained can be controlled by adjusting the degree of evaporating the moisture of the concentrated brine and drying it, in other words, by adjusting the amount of the remaining aqueous solution (mother solution). The water vapor obtained by evaporative concentration is discharged as distilled water to a river or the ground from where underground brine is pumped up after utilizing the latent heat, and apart of it can be mixed with the diluting water used for the electrodialysis device to reuse it.

The solid salt obtained by evaporating water can be made into a salt product through, for example, a step of separating an aqueous solution (mother solution) by a dehydration operation and drying it. A suction filter or a centrifuge is preferably used for the dehydration operation. By controlling the degree of dehydration operation, the amount of the aqueous solution (mother solution) remaining in the salt solid can be adjusted, and iodine-containing salt having an adjusted iodide ion content in the obtained salt can be obtained. A heating furnace, a blower dryer, or a vacuum dryer are preferably used for drying the salt.

The salt obtained by the method for co-producing iodine and salt of the present invention is preferably an iodine-containing salt containing 1 mg/kg or more of iodide ions.

Thereby, for example, it can be more preferably used as salt for human food and salt for feed of livestock and pets.

The upper limit of iodine ions in the salt obtained by the method for co-producing iodine and salt of the present invention is not particularly limited, but is preferably less than 10,000 mg/kg.

Thereby, for example, it can be more preferably used as salt for human food and salt for feed of livestock and pets.

In this embodiment, the iodine ion content in the salt obtained through the roasting step can be increased as compared with other embodiments described later. In this present embodiment, the iodine ion content in the iodine-containing salt is preferably 5 mg/kg or more, and more preferably 10 mg/kg or mow and 1000 mg/kg or less.

The iodine ion content in the salt obtained by the method of the present embodiment is preferably less than 1,000 mg/kg, more preferably less than 500 mg/kg.

The iodine-containing salt obtained in the present invention is in the form in which the iodine salt is uniformly incorporated into the solid salt, and the undesired variation in the iodine ion content in the solid salt is effectively suppressed.

As described above, the salt obtained in the roasting step usually contains sodium chloride as a main component. The content of sodium chloride in the salt obtained in the roasting step is preferably 75% by mass or mow, more preferably 80% by mass or more, and further preferably 90% by mass or more.

The salt produced by the present invention can be used, for example, as salt for human food, salt for raw materials for livestock or pet feed, and the like. When the iodine ion content of the produced salt is high, it is possible to produce salt having an adjusted iodine ion content, for example, by mixing with salt containing substantially no iodine salt, or by roasting with an aqueous solution of salt containing substantially no iodine salt. Further, when the produced salt is iodine-containing salt containing iodine ions in an appropriate range, it can be used as it is, and can sell as a commercial product, for example.

Further, to the salt obtained by the present invention, components other than the components of the salt, for example, an antioxidant such as glucose, an anticaking agent such as calcium silicate, an auxiliary salt such as magnesium chloride, etc. are added so that it can be used as a salt-containing composition.

### Iodine Acquisition Step

In the iodine acquisition step, iodine is obtained from the object to be heated containing an iodine salt, particularly in this present embodiment, the waste water remaining as an aqueous solution (mother liquor) separated from the solid phase salt not solidified in the roasting step. Water, for example, may be added to the object to be treated containing an iodine salt if necessary. As the iodine acquisition step, a blowing-out method, a resin adsorption method or an absorption method can be preferably adopted.

The iodine acquisition step by the blowing-out method is a process, which includes an oxidation step of mixing an oxidizing agent such as chlorine or sodium hypochlorite with an object to be treated containing an iodine salt to produce molecular iodine; a blowing-out step of blowing a gas such as air in the heated product to vaporize iodine into the blowing-out tower, an absorption step of absorbing iodine by contacting the iodine-containing gas emitted from the blowing-out tower with water containing a reducing agent such as sodium sulfite to obtain an absorption liquid; and a crystallization step of adding an oxidizing agent to the obtained absorption liquid to precipitate iodine to obtain high purity iodine. The oxidation step by mixing the oxidizing agents in the blowing-out method is preferably performed under the condition that the pH of the object to be subjected to the oxidation step is close to neutral. More specifically, the pH of the object in the oxidation step is preferably 4 or more and 10 or less, more preferably 5 or more and 9 or less, and further preferably 5 or more and 8 or less.

The iodine acquisition step by the resin adsorption method is an iodine production process including an oxidation step of mixing an oxidizing agent such as chlorine or sodium hypochlorite with an object to be treated containing an iodine salt to generate polyiodine ions such as I₃⁻; an adsorption step in which the object to be treated after the oxidation step is introduced into a fluidized layer type adsorption tower filled with an anion exchange resin to adsorb polyiodine ions; an elution step in which the polyiodine ions adsorbed on the anion exchange resin are subjected to reducing with a reducing agent such as sodium sulfite and bringing it into contact with an eluent such as dilute hydrochloric acid or saline to elute iodine; a concentration step of precipitating crude iodine by adding an oxidizing agent to the eluent in which iodine has been eluted; and a purification step of purifying crude iodine. The oxidation step using an oxidizing agent in the resin adsorption method is preferably carried out under the condition that the pH of the object to be subjected to the oxidation step is around neutral. More specifically, the pH of the object to be heated in the oxidation step is preferably 4 or more and 10 or less, more preferably 5 or more and 9 or less, and further preferably 5 or mow and 8 or less.

The iodine acquisition step by the absorption method is a method in which an iodine salt-containing object to be heated and an oxidizing agent are mixed to generate iodine, which is then absorbed by a solvent. The absorption method is a method in which iodine ions are oxidized to generate iodine and the produced iodine is separated, by utilizing the property that iodine is soluble in an organic solvent. Specifically, the pH of the object to be treated containing an iodine salt is adjusted to 4 or more and 8 or less, an oxidizing agent such as chlorine is added to liberate iodine, iodine is extracted with an organic solvent, and an organic solvent containing iodine is contacted with water containing a reducing agent such as sodium sulfite and let iodine absorbed to obtain an absorption liquid; and a crystallization step in which an oxidizing agent is added to obtain high-purity iodine by precipitating iodine.

In this present embodiment, as the object to be subjected to the iodine acquisition step is underground brine concentrated through the collecting step and the roasting step, and the iodine salt concentration is increased, acquiring iodine in the acquisition process becomes easier. Further, since the amount of the object to be treated is reduced, the scale of the apparatus in the iodine acquisition step and the amount of chemicals such as sulfuric acid to be added can be reduced.

The iodine obtained in the iodine acquisition step is usually of relatively high purity. The purity of iodine obtained in the iodine acquisition step is preferably 99.0% by mass or more, and more preferably 99.7% by mass or more.

The wastewater in the iodine acquisition step, particularly when the blowing-out method or the resin adsorption method is adopted, the wastewater still contains some iodine salts in addition to the salt component. Therefore, it is preferable to recycle the wastewater in the iodine acquisition step to the collecting step or the roasting step, as shown in FIG. 1, from the viewpoints of further improvement of the iodine acquisition rate, economic efficiency and the like. When wastewater is recycled, if the wastewater is acidic, it is preferable to neutralize it with alkali, and if the wastewater contains an oxidizing agent such as chlorine, it is preferable to decompose it with a reducing agent such as sodium sulfite.

The waste water generated in the method of the present invention, that is, the low-concentration salt water discharged in the collecting step, and the distilled water discharged in the roasting step, can be discharged into a river, for example, and preferably returned to the ground from where brine has been pumped.

### Second Embodiment

Next, the method for co-producing iodine and salt of the present invention according to the second embodiment will be described.

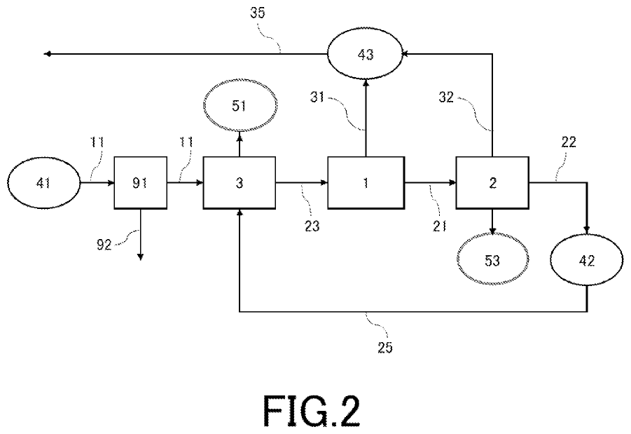

FIG. 2 is a flow chart showing a method for co-producing iodine and salt according to the second embodiment of the present invention.

Hereinafter, the method for co-producing iodine and salt of the present invention according to the second embodiment will be described with reference to this figure, but the differences from the above-described embodiment will be mainly described, and similar matters will be omitted from the description.

In this present embodiment, the iodine acquisition step, the collecting step, and the roasting step are performed in this order in the series of steps.

More specifically, first, the underground brine 11 in the underground brine storage tank 41 is conveyed to the aeration/filtration device 91 for pretreatment. The insoluble matter 92 produced by the pretreatment is filtered and removed by a filter medium (not shown).

The underground brine 11 from which the insoluble matter generated by the pretreatment has been removed is transported to the iodine acquisition device 3 to perform an iodine acquisition step.

Iodine 51 is obtained by the iodine acquisition step in the iodine acquisition device 3. The iodine-acquired wastewater 23 remaining after the iodine 51 is acquired in the iodine acquisition step is transported to the electrodialysis device 1 and subjected to a collecting step. The concentrated brine 21 obtained in the collecting step of the electrodialysis device 1 is transported to the roasting device 2, and the low-concentration salt water 31 obtained by the electrodialysis device 1 is transported to the return water storage tank 43.

The concentrated brine 21 is subjected to the roasting step in the roasting device 2.

By the roasting step in the roasting device 2, the salt 53 as a solid is obtained, and the roasting mother liquor 22 which is separated from the salt 53 and contains iodine at a higher concentration than the concentrated brine 21 is also obtained. The roasting mother liquor 22 is transported to the recycled water storage tank 42, and then is transported to the iodine acquisition device 3 as recycled water 25, so that it can be suitably recycled. Further, the distilled water 32 obtained by condensing the water evaporated by the roasting device 2 is recovered as a liquid and transported to the return water storage tank 43.

The low-concentration salt water 31 and the distilled water 32 collected in the return water storage tank 43 can be discharged to a river, for example, and preferably returned to the underground where the brine has been mined.

As described above, by performing the iodine acquisition step, the collecting step, and the roasting step in this order in the series of steps, the iodine ion concentration in the low-concentration salt water becomes low, and the effect of increasing usage of iodine ion in the underground brine can be obtained.

### Iodine Acquisition Step

In this present embodiment, the underground brine as the object to be treated is preferably maintained in a non-oxidizing state or blown with air to perform pretreatment such as filtration, and then is sent to the iodine acquisition process to obtain iodine. As the iodine acquisition step, a blowing-out method or a resin adsorption method can be preferably used.

### Collecting Step

The waste water from the iodine acquisition step is sent to the collecting step. It is divided by an electrodialysis device into concentrated brine, which is an aqueous solution containing sodium chloride and iodine salts at relatively high concentrations, and low-concentration salt water, which is an aqueous solution containing sodium chloride and iodine at relatively low concentrations.

The wastewater in the iodine acquisition step is preferably one in which the residual oxidizing agent is decomposed, neutralized, and filtered in advance when it is used in the collecting step.

### Roasting Step

The concentrated brine is neutralized if necessary and then sent to the roasting step to evaporate water and concentrated to produce solid salt. In the roasting step, by adjusting the amount of the residual aqueous solution (mother solution), the iodine ion content contained in the solid salt produced can be adjusted.

In this present embodiment, iodine-containing salt having an iodine ion content of 10 mg/kg or more, for example, 10 mg/kg or more and 500 mg/kg or less can be produced.

The wastewater (mother solution) in the roasting process still contains some iodine salts in addition to the salt component. Therefore, it is preferable to recycle the wastewater (mother solution) in the roasting process to the iodine acquisition step from the viewpoints of further improvement of the iodine acquisition rate, economic efficiency, and the like. When recycling the wastewater, the wastewater may be neutralized if necessary.

In the constitution shown in FIG. 2, the wastewater after the roasting process is recycled to the iodine acquisition step, and the low-concentration salt water and distilled water are returned to the ground where the underground brine is mined.

### Third Embodiment

Next, the method for co-producing iodine and salt of the present invention according to the third embodiment will be described.

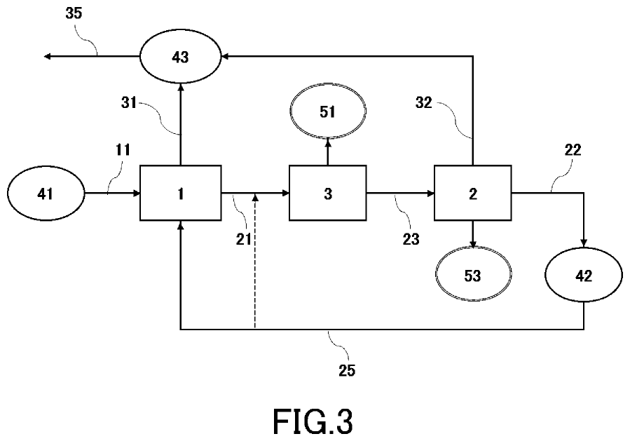

FIG. 3 is a flow chart showing a method for co-producing iodine and salt according to the third embodiment of the present invention.

Hereinafter, the method for co-producing iodine and salt of the present invention according to the third embodiment will be described with reference to this figure, but the differences from the above-described embodiments will be mainly described, and the same matters will be omitted.

In this present embodiment, the collecting step, the iodine acquisition step, and the roasting step are performed in this order in the series of steps.

More specifically, first, the underground brine 11 in the underground brine storage tank 41 is transported to the electrodialysis device 1 to perform a collection step.

The concentrated brine 21 obtained by the electrodialysis device 1 in the collecting step is transported to the iodine acquisition apparatus 3, and the low-concentration salt water 31 obtained by the electrodialysis device 1 is transported to the return water storage tank 43.

The concentrated brine 21 is subjected to an iodine acquisition step in the iodine acquisition device 3. Iodine 51 is obtained by the iodine acquisition step in the iodine acquisition device 3. The iodine-acquired wastewater 23 that remains after the iodine 51 is acquired in the iodine acquisition step is transported to the roasting device 2.

The iodine-acquired wastewater 23 conveyed to the roasting device 2 is subjected to the roasting process.

The salt 53 as a solid is obtained by the roasting device 2 in the roasting step. Further, the roasting mother liquor 22 separated from the salt 53 by the roasting step in the roasting device 2 and containing iodine at a higher concentration than the iodine-acquired wastewater 23 is transported to the recycled water storage tank 42. Then it is transported to the electrodialysis device 1 and can be suitably recycled. Further, the distilled water 32 obtained by condensing the water evaporated in the roasting step is recovered as a liquid and transported to the return water storage tank 43. The low-concentration salt water 31 and the distilled water 32 collected in the return water storage tank 43 can be discharged to a river, for example, and preferably returned to the underground where the brine was mined.

As described above, by performing the collecting step, the iodine acquisition step, and the roasting step in this order in the series of steps, the following effects can be obtained.

That is, in this present embodiment, since the underground brine as the object to be treated is concentrated through the collecting step and the concentration of the iodine salt increases, iodine acquisition in the iodine acquisition step becomes easier.

Further, since organic substances such as fulvic acid are removed through the collection step from the underground brine as the object to be treated, the by-product of the organic iodine compound in the iodine acquisition step is more effectively suppressed. Further, since the amount of underground brine as an object to be treated is reduced, the scale and power of the apparatus in the iodine acquisition step and the amount of chemicals such as sulfuric acid to be added can be reduced. In the apparatus of the iodine acquisition step, the precipitation of transition metal oxides is further suppressed. In addition, the effect of increasing the yield of iodine obtained can be obtained.

Collecting Step

In this present embodiment, the underground brine as the object to be treated is preferably maintained in a non-oxidizing state, subjected to pretreatment such as filtration, and then sent to the collecting step. It is divided by an electrodialysis device into concentrated brine, which is an aqueous solution containing a relatively high concentration of sodium chloride and iodine salt, and low-concentration salt water, which is an aqueous solution containing a relatively low concentration of sodium chloride and iodine salt.

### Iodine Acquisition Step

The concentrated brine obtained in the iodine acquisition step is sent to the iodine acquisition step to acquire iodine. As the iodine acquisition step, a blowing-out method, a resin adsorption method or an absorption method can be preferably used.

### Roasting Step

The wastewater in the iodine acquisition step is sent to the roasting step to evaporate water and get concentrated to produce solid salt. In the roasting step, when the amount of the residual aqueous solution (mother solution) is adjusted, the iodine ion content in the produced salt can be adjusted.

In this present embodiment, salt having an iodine ion content of 10 mg/kg or mole, for example, 10 mg/kg or more and 100 mg/kg or less can be produced. Such salt, that is, iodine-containing salt, contains iodine ions in a more suitable range as an edible salt. Therefore, it is more suitable as a commercial product.

The wastewater (mother solution) in the roasting process contains an iodine salt in addition to the salt component.

Therefore, it is preferable that the wastewater (mother solution) in the roasting process is recycled to the collecting step or the iodine acquisition step. When the wastewater is recycled, the wastewater may be neutralized if necessary.

In the constitution shown in FIG. 3, the wastewater after the roasting process is recycled to the collecting step or the iodine acquisition step, and the low-concentration salt water and distilled water are returned to the ground where the underground brine is mined.

Although preferred embodiments of the present invention have been described above, the present invention is not limited thereto. For example, it is permissible to change the conditions within the scope of the gist of the present invention, or to make modifications such as adding other steps.

Hereinafter, the present invention will be described in more detail with reference to Examples.

### Example 1

### Brine as Raw Material

Underground brine (sodium chloride content 22 g/L, iodide ion 32 mg/L) pumped from the ground at a depth of 1000 m was aerated and filtered by an aeration/filtration device. Insoluble matter such as oxidized iron was removed to prepare raw material brine.

### Collecting Step

Using the raw material brine, electrodialysis was performed using an electrodialysis device including an electrodialysis tank (manufactured by Asahi Kasei Corporation, G4 type).

A pair of electrodes were arranged on both sides of the electrodialysis tank, and one electrode was used as an anode (positive electrode) and the other electrode was used as a cathode (negative electrode). Anion exchange membranes and cation exchange membranes were alternately arranged between these electrodes from the anode side to the cathode side. Selemion ASV-N (manufactured by AGC Co., Ltd.), which is a monovalent anion selective permeation membrane, was used for the anion exchange membrane, and Selemion CSO (manufactured by AGC Co., Ltd.), which is a monovalent cation selective permeation membrane, was used for the cation exchange membrane. The effective area of the ion exchange membrane was 0.02 m² per membrane. The electrodialysis tank was separated into a concentrating chamber and a diluting chamber by these ion exchange membranes, and five sets were repeatedly arranged while two chambers and two membranes from the concentrating chamber to the cation exchange membrane were one set.

A DC current of 6 V was applied between the cathode and the anode, and the diluting chamber was supplied with 12 L of the filtered underground brine, and the concentrating chamber was supplied with 500 mL of a chamber liquid consisting of an aqueous solution of sodium chloride of 24 g/L at 0.2 L/min. The operation was performed by passing the liquid and circulating the liquid discharged from each room.

After 6 hours of operation, 1.6 L of concentrated brine (sodium chloride content 153 g/L, iodine ion content 230 mg/L) was obtained from the concentrating chamber, and 10.9 L of low-concentration salt water (sodium chloride content 4 g/L, iodide ion content 1.3 mg/L) was obtained from the diluting chamber.

The iron ion content of the raw material underground brine was 0.2 mg/L, and the manganese ion content was 0.2 mg/L. The iron ion content in the concentrated brine obtained in the collecting step was 0.01 mg/L, and the manganese ion content was 0.01 mg/L.

### Roasting Step

200 ml of concentrated brine obtained from the concentrating chamber in the collecting step was heated and evaporated to form a slurry. Then, suction filtration was performed to separate it into a solid and a roasting mother liquor (bittern), and the solid was dried to obtain 19 g of iodine-containing salt. The obtained iodine-containing salt contained iodine ions uniformly at 223 mg/kg. The salt concentration of the roasting mother liquor was 300 g/L, and the iodine ion concentration was 1075 mg/L. The acquisition rate of iodine-containing salt with respect to sodium chloride contained in the raw material underground brine was 57%.

### Iodine Acquisition Step

A small amount of sulfuric acid aqueous solution was added to the aqueous solution (roasting mother liquor) filtered in the roasting step to adjust the pH to 4, and a sodium nitrite solution was added to convert the contained iodine ions into free iodine. Then, free iodine was extracted with dibutyl ether to prepare an iodine dibutyl ether solution, and iodine was quantified from the absorbance at 472 nm. The acquisition rate of iodine with respect to iodine ions contained in the raw material underground brine was 80%.

### Example 2

### Iodine Acquisition Step

Using the raw material brine obtained in the same manner as in Example 1, chlorine gas was mixed into it to convert iodine ions to free iodine. It was sprayed in the blowing-out tower, and at the same time a large amount of air was introduced. The air that came out of the top of the blowing-out tower was sent to the absorption tower, and was sufficiently contacted with an absorption liquid consisting of an aqueous sodium sulfite solution to absorb molecular iodine and obtain it. The acquisition rate of iodine with respect to iodine ions contained in the raw material underground brine was 57%. The brine (wastewater) after passing through the blowing-out tower contained 21 g/L, of salt and 4.2 mg/L of iodine ions (15 mg/L when iodine other than iodide ions was included).

### Collecting Step

The underground brine discharged from the bottom of the blowing-out tower in the iodine acquisition step was added with sodium sulfite to decompose the residual oxidizing agent, neutralized, filtered, and then subjected to the collecting process under the same conditions as in Example 1.

While DC current of 6 V was applied between the cathode and the anode, 12 L of the filtered underground brine was supplied to the diluting chamber, and 500 mL of a chamber liquid consisting of an aqueous solution of sodium chloride of 24 g/L was supplied to the concentrating chamber at 0.2 L/min. The operation was performed by circulating the liquid discharged from each room.

After 6 hours of operation, 1.5 L of concentrated brine (sodium chloride content 132 g/L, iodide ion content 25 mg/L) from the concentrating chamber and 11 L of low-concentration salt water (sodium chloride content 5 g/L, iodide ion content 1 mg/L) from the diluting chamber were obtained.

In the underground brine discharged from the bottom of the blowing-out tower in the iodine acquisition step, the iron ion content was 0.2 mg/L and the manganese ion content was 0.1 mg/L. In the concentrated brine obtained in the collecting step, the iron ion content was 0.01 mg/L and the manganese ion content was 0.01 mg/L.

### Roasting Step

In the roasting step, 200 ml of concentrated brine obtained from the concentrating chamber was heated and evaporated to form a slung, which was suction-filtered to separate it into a solid and a roasting mother liquor (bittern), and the solid was dried to obtain 7 g of iodine-containing salt. The obtained iodine-containing salt contained iodine ions uniformly at 34 mg/kg. In iodine-containing salt, the acquisition rate of sodium chloride with respect to sodium chloride contained in the raw material underground brine was 46%.

Moreover, 37 mL of roasting mother liquor was obtained. The salt concentration of the roasting mother liquor was 300 g/L, and the iodine ion concentration was 117 mg/L. 8% of the iodide ions in the raw material brine remained in the roasting mother liquor. By adding this roasting mother liquor to the raw material brine in the iodine acquisition step and recycling it, the yield of iodine ions becomes 65%.

### Example 3

### Collecting Step

Using the raw material brine obtained in the same manner as in Example 1, a collecting step was carried out under the same conditions as in Example 1.

After 6 hours of operation, 1.6 L of concentrated brine (sodium chloride content 153 g/L, iodine ion content 230 mg/L) was obtained from the concentrating chamber. 10.9 L of low-concentration salt water (sodium chloride content 4 g/L, iodide ion content 1.3 mg/L) was obtained from the diluting chamber.

### Iodine Acquisition Step

Using the raw material brine obtained as described above, it was mixed with chlorine gas to convert iodide ions into free iodine, which was sprayed into the blowing-out tower, and at the same time a large amount of air was blown into it. The air that came out of the top of the blowing-out tower was sent to the absorption tower, and was sufficiently contacted with an absorption liquid consisting of an aqueous sodium sulfite solution to absorb molecular iodine and obtain it. The acquisition rate of iodine with respect to iodine ions contained in the raw material underground brine was 91%. The remaining concentrated brine (wastewater) was 200 ml, and contained 153 g/L of salt and 5 mg/L of iodine ions.

The iron ion content of the raw material underground brine was 0.2 mg/L, and the manganese ion content was 0.2 mg/L. The iron ion content in the concentrated brine obtained in the collecting step was 0.01 mg/L, and the manganese ion content was 0.01 mg/L.

### Roasting Step

The same roasting step as in Example 1 was carried out using concentrated brine after the iodine acquisition step.

19 g of salt was obtained from the wastewater of the iodine acquisition step. The iodine content in the salt was 5 mg/kg. In addition, 37 mL of roasted mother liquor was obtained, and its iodine content was 25 mg/L. The acquisition rate of iodine-containing salt with respect to sodium chloride contained in the raw material underground brine was 57%.

When the blowing-out method was performed by using the underground brine directly, the iodine yield from the underground brine was 57%. However, according to the method of the present invention, the iodine yield from the underground brine was 90% in the first embodiment (Example 1), 65% in the second embodiment (Example 2), and 91% in the third embodiment (Example 3), which are significantly increased.

By using the method of the present invention, iodine can be obtained and produced from underground brine in a higher yield. In the above example, it was confirmed that iodine and salt can be co-produced industrially and efficiently.

The method for co-producing iodine and salt of the present invention is a method for co-producing iodine and salt using underground brine containing iodine salt and sodium chloride. It comprises a series of steps including an iodine acquisition step, a collecting step of simultaneously concentrating an iodine salt and sodium chloride to obtain concentrated brine using an electrodialysis device, and a roasting step of obtaining salt. It produces iodine and salt in parallel.

According to the method for co-producing iodine and salt of the present invention, iodine and salt can be co-produced industrially and efficiently. In particular, iodine and iodine-containing salt can be efficiently produced at the same time.

Therefore, the method for co-producing iodine and salt of the present invention has industrial applicability.

Iodine and salt produced by the present invention are important industrial products. For example, the salt produced by the present invention can be used for human foal, or as a raw material for feed for fish, livestock or pets.

### SYMBOLS

1 Electrodialysis device
2 Roasting device
3 Iodine acquisition device
11 Underground brine
21 Concentrated brine
22 Roasting mother liquor
23 Iodine acquired waste water
25 Recycled water
31 Low-concentration salt water
32 Distilled water
35 Underground return water
41 Underground brine storage tank
42 Recycled water storage tank
43 Return water storage tank
51 Iodine
53 Salt
91 Air exposure/filtration device
92 Insoluble matter.

1. A method for co-producing iodine and salt, comprising:
producing the iodine and salt in parallel using underground brine containing iodine salt and sodium chloride,
wherein the method comprises a series of steps including an iodine acquisition step, a collecting step for obtaining simultaneously concentrating iodine salt and sodium chloride by using an electrodialysis device to obtain concentrated brine, and a roasting step for obtaining the salt.

2. The method for co-producing iodine and salt according to claim 1, wherein the underground brine contains 1 mg/L or more of iodine ions and 1 g/L or more of sodium chloride.

3. The method for co-producing iodine and salt according to claim 1, wherein the salt obtained in the roasting step is iodine-containing salt having an iodine ion content of 1 mg/kg or more.

4. The method for co-producing iodine and salt according to claim 1, wherein the concentrated brine from which transition metal ions have been removed is obtained by using a monovalent ion selective permeable cation exchange membrane in the electrodialysis device in the collecting step.

5. The method for co-producing iodine and salt according to claim 1, wherein an iodine ion concentration in the concentrated brine obtained by the electrodialysis device is four times or more an iodine ion concentration in the underground brine supplied to be treated in the collecting step.

6. The method for co-producing iodine and salt according to claim 1, wherein the collecting step, the roasting step, and the iodine acquisition step are carried out in this order in the series of steps.

7. The method for co-producing iodine and salt according to claim 6, wherein wastewater after the iodine acquisition step is recycled to the collecting step or the roasting step.

8. The method for co-producing iodine and salt according to claim 1, wherein the iodine acquisition step, the collecting step, and the roasting step are carried out in this order in the series of steps.

9. The method for co-producing iodine and salt according to claim 8, wherein wastewater after the roasting step is recycled to the iodine acquisition step.

10. The method for co-producing iodine and salt according to claim 1, wherein the collecting step, the iodine acquisition step, and the roasting step are carried out in this order in the series of steps.

11. The method for co-producing iodine and salt according to claim 10, wherein wastewater after the roasting step is recycled to the iodine acquisition step or the collecting step.
